(19) United States
(12) Patent Application Publication
(10) Pub. No.: US 2005/0054501 A1
(43) Pub. Date: Mar. 10, 2005

(54) Device and system for measuring the properties of multi-segmented filters and corresponding method

(76) Inventor: Dierk Schroder, Hamburg (DE)

Correspondence Address: VENABLE, BAETJER, HOWARD AND CIVILETTI, LLP, P.O. BOX 34385, WASHINGTON, DC, 20043-9998, US

(21) Appl. No.: 10/500,089

(22) PCT Filed: Nov. 23, 2002
(86) PCT No.: PCT/EP02/13186

(30) Foreign Application Priority Data
Dec. 27, 2001 (DE) 10163761.6

(51) Int. Cl. B31C 13/00

(52) U.S. Cl. 493/39

(57) ABSTRACT

The invention relates to a device for measuring the properties of multi-segmented filters (61 to 64) in the tobacco-processing industry by means of X-ray crystallographic analysis. The inventive device comprises a radiation source (81) and a radiation receiver (80, 82). A multi-segmented filter (61 to 64) can be radiated in an essentially uniform manner along the longitudinal axis by means of said radiation source (81). The invention also relates to a system for measuring the properties of rod-shaped articles and a method for assuring the quality of filter cigarettes having multi-segmented filters. The radiation receiver (82, 80) of the inventive device is arranged inside a conveying element (21, 31, 34) used to convey at least multi-segmented filters (61 to 64). The inventive system is provided with at least two measuring devices, one of which operates according to the reflection method while the other one uses X-ray crystallographic analysis.

The invention relates to a device for measuring the properties of multi-segmented filters in the tobacco-processing industry by means of a light-transmission method, said device comprising a radiation source and a radiation receiver, wherein the radiation source can be used to radiate a multi-segmented filter in essentially uniform manner and along the longitudinal axis.

The invention furthermore relates to a system for measuring the properties of rod-shaped articles or components of rod-shaped articles which are combined to form a single rod-shaped article in the tobacco-processing industry, in particular multi-segmented filters and/or filter cigarettes provided with multi-segmented filters, wherein a first measuring device is provided for measuring the articles or components of the articles with the aid of a reflection method.

Finally, the invention relates to a method for assuring the quality of filter cigarettes with multi-segmented filters.

For the production of filter cigarettes with multi-segmented filters, the quality assurance represents a critical aspect.

Reference DE-PS 1 188 493, which corresponds to U.S. Pat. No. 3,040,179, discloses a measuring device for measuring with the aid of a light-transmission method whether filter segments are positioned at the correct distance to each other. For this, light is radiated from a light source that is positioned inside a conveying drum toward the outside of the conveying drum where it is received by corresponding receiving elements. If the filter segments are positioned too closely together, the receivers will receive less light and if the filter segment are spaced apart too far, the receivers will receive more light, thus making it possible to measure the distance between the filter elements.

Reference DE-AS 1 532 119 also discloses a device for testing filters, which uses a light-transmission method for guiding light from inside a conveying drum through the filter elements, such that it can be recorded by a measuring device.

The multi-segmented filters and/or multiple-component filters desired nowadays, however, have noticeably more complicated filter structures, so that a relatively inexact measuring as disclosed in the aforementioned references, is not sufficient for the quality assurance.

Thus, it is the object of the present invention to provide a measuring device, a measuring system and a method for assuring the quality of filter cigarettes with multi-segmented filters, by means of which reliable and relatively accurate information can be obtained on whether the quality of the filter cigarettes and the corresponding multi-segmented filters is sufficient.

This object is solved with a device for measuring the properties of multi-segmented filters in the tobacco-processing industry by means of a light-transmission method, said device being provided with a radiation source and a radiation receiver for radiating a multi-segmented filter in an essentially uniform manner along the longitudinal axis. The device is further modified in that the radiation receiver is arranged inside a conveying element, provided for conveying at least multi-segmented filters.

The measure according to the invention makes it possible to realize corresponding measuring operations with less scattered light, thus achieving improved measuring results. The device according to the invention furthermore makes it possible to realize a measurement with spatial resolution, by means of which extremely accurate information can be obtained on the position and/or existence of filter elements.

If the radiation device consists of a plurality of radiation sources arranged along the longitudinal axis of a receiving trough in a conveying element, an extremely uniform radiating of the parts and/or segments of the filter cigarettes and/or the multi-segmented filters to be measured is possible. A particularly cost-effective radiation source with long service life is achieved if the individual radiation sources are preferably light-emitting diodes.

The radiation receiver preferably consists of at least one receiving element that extends along the longitudinal axis of a receiving trough arranged in the conveying element, or consists of a plurality of receiving elements extending along the longitudinal axis of a receiving trough arranged in the conveying element.

One advantageous embodiment of the invention, having a receiving element that extends along the longitudinal axis, preferably uses a line-scanning camera which comprises a CCD (charged coupled device and/or a charged-coupled circuit). For this, we refer to reference DE 36 28 088 C2 which discloses charge coupled devices of this type. The receiving elements preferably comprise photodiodes, wherein this preferred embodiment of the invention results in a particularly cost-effective realization with long service life.

The object is furthermore solved with a system for measuring the properties of rod-shaped articles or components of rod-shaped articles in the tobacco-processing industry, subsequently combined to form a single article, in particular multi-segmented filters and/or filter cigarettes provided with multi-segmented filters, wherein a first measuring device is provided for measuring the articles or components of the articles with a reflection method and which is further modified in that a second measuring device is provided for measuring the articles or components of the articles by means of a light-transmission method.

Considerably more precise measuring results can be obtained with this solution for the properties of the rod-shaped articles and/or the components of the rod-shaped articles because the solution combines two different measuring methods and/or measuring techniques, so that inaccuracies resulting from one measuring technique can be compensated for with the other measuring technique.

The second measuring device preferably is a measuring device according to the invention as described in the above.

If, as is preferable, a third measuring device is provided for measuring the articles or components of the articles with the aid of a reflection technique, essentially no defective cigarettes are missed by the quality control.

According to one embodiment of the invention, the measuring devices are arranged in and/or on a filter tipping machine. If the first measuring device is arranged in an area located downstream of a station where the article components are combined in a production process for rod-shaped articles, for example in front of a tipping paper rolling device, it is possible in a particularly easy and elegant manner to detect the full number of the filter components as well as the position of the filter components and the length of the individual components. To some degree it is also possible to measure deviations in the density of individual filter components.

The first measuring device is preferably arranged on and/or in a transfer drum that is positioned downstream of a first drum for combining the components.

If the second and/or third measuring device is arranged in a region of the production process for rod-shaped articles which is located downstream of a station for the at least partial wrapping of the articles with a tipping paper, then the position of the tipping paper edge as well as the imprint on a tipping paper can be detected, for example, with the third measuring device. Gaps between filter components, missing filter components as well as deviations in the density of individual filter components can be detected with the second measuring device.

The stations comprise preferably at least in part drums and/or conveying drums.

According to one preferred embodiment of the invention, the first and/or third measuring device comprises a radiation source by means of which the rod-shaped articles or components of rod-shaped articles can essentially be radiated within a measuring range, wherein the first and/or third measuring device comprises a radiation receiver which receives the radiation reflected by the articles or the components. A cost-effective measuring system with high service life can be achieved if the radiation receiver consists of a plurality of individual receivers, arranged in a row. Particularly precise information relating to the position of filter elements and/or the components of the filter cigarettes is obtained if the radiation receiver is a position-sensitive receiver that extends in at least one direction and in particular comprises a CCD. With respect to this, we point to reference DE 36 28 088 C2, which discloses a technique using a line-scanning camera with CCDs for the optical testing of the surface of rod-shaped smoking articles and/or filter rods in the tobacco-processing industry when wrapped cigarettes are tested.

A filter tipping machine is preferably provided with at least one measuring device and/or a measuring system according to the invention, as described in the above.

This object is furthermore solved with a method for the quality assurance of filter cigarettes with multi-segmented filters, wherein the radiation reflected by the filter components of the multi-segmented filters is compared in a first measuring device to first set values by using a reflection technique and wherein the filter cigarette or the filter cigarette components are discarded if the deviation values exceed a first predetermined tolerance range.

Within the framework of this invention, the term “discarded” means that the items in particular are also excluded from further processing. The method according to the invention therefore permits an easy quality assurance of filter cigarettes.

The accuracy is increased when using a light-transmission method in a second measuring device for comparing the values for the radiation that has passed through the filter components of the multi-segmented filters and the tipping paper wrapped around these components to second set values, wherein the filter cigarette is discarded if the values deviate in excess of values for a second predetermined tolerance range. Within the framework of this invention, a gap is also understood to be a filter component.

An even more precise and improved quality assurance is possible with the aid of a third measuring device, using a reflection technique for comparing the radiation reflected by a tipping paper wrapped around the multi-segmented filters to desired third values, wherein the filter cigarette is discarded if the values deviate in excess of a third predetermined tolerance range.

The invention is described in the following without restricting the general inventive idea by using exemplary embodiments and referring to the drawings, wherein we expressly refer to the drawings for all details of the invention not further explained in the text. Shown are in:

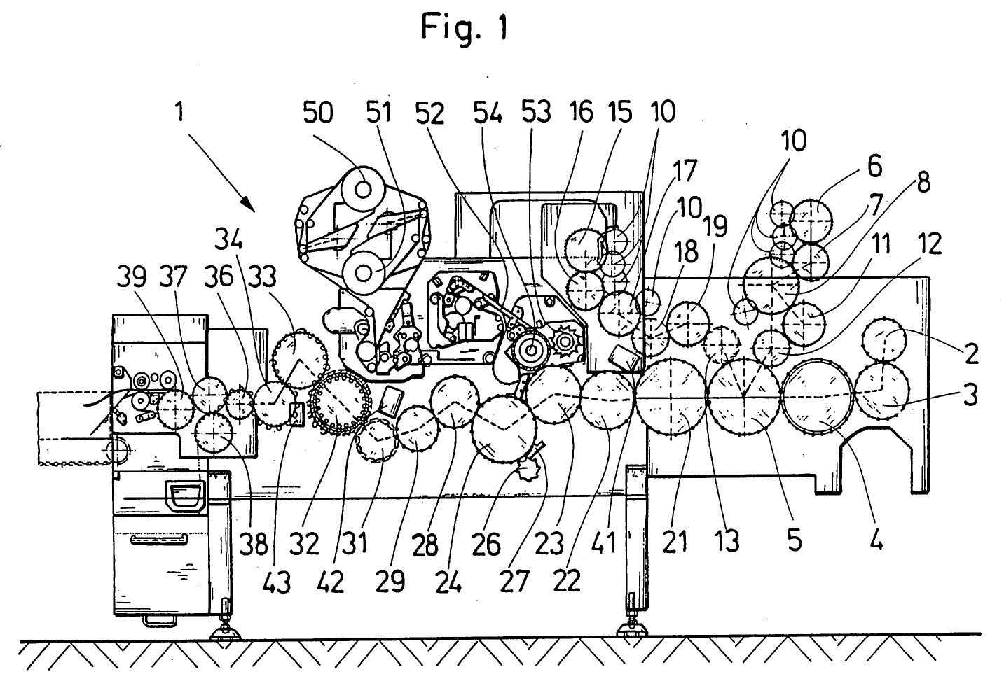

FIG. 1 A schematic view from the side of a filter tipping machine;

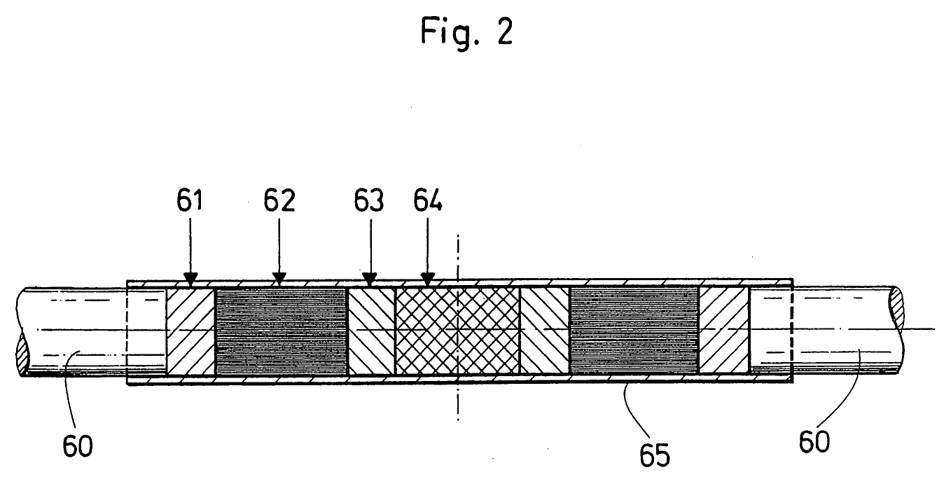

FIG. 2 A schematic cross-sectional representation of a portion of a double filter cigarette;

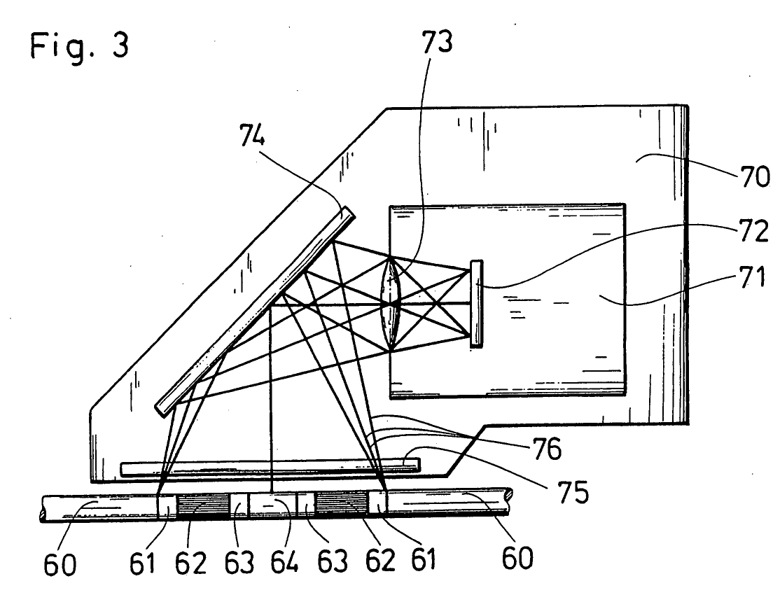

FIG. 3 A schematic view from the side of a measuring device according to the invention;

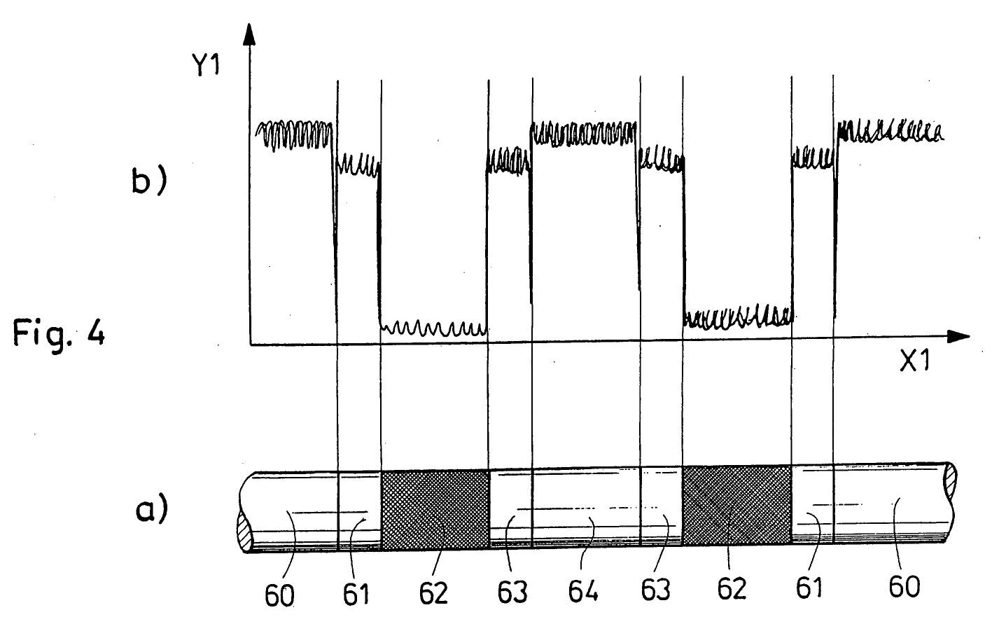

FIG. 4 A measuring result, shown schematically, which is obtained with a measuring device according to the invention as shown in FIG. 3;

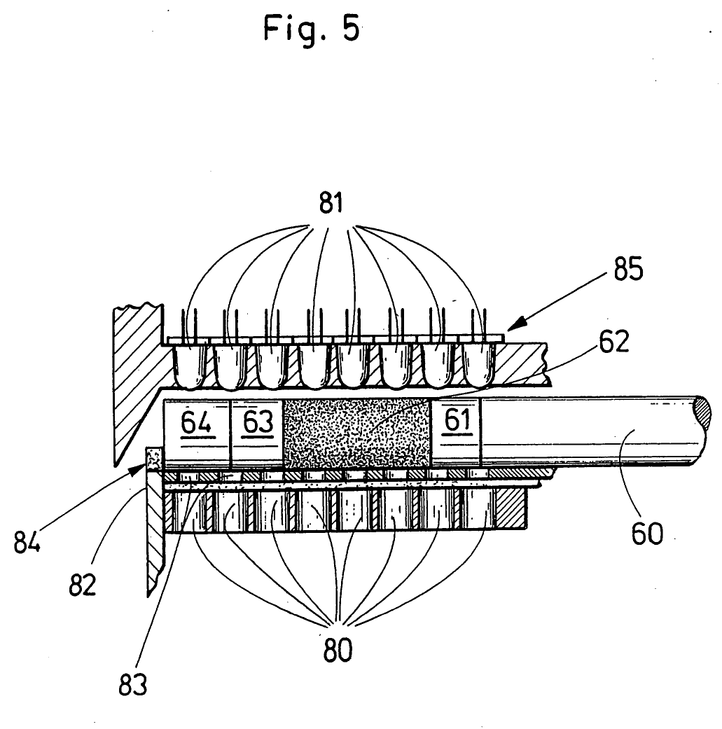

FIG. 5 A schematic cross-sectional representation of a second measuring device according to the invention;

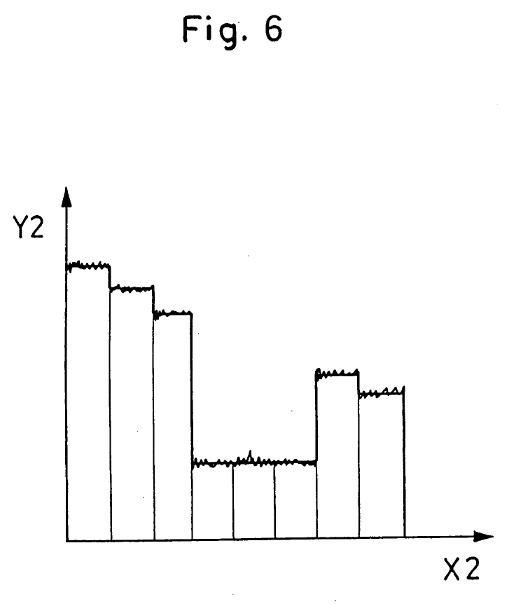

FIG. 6 A measuring result, shown schematically, which is obtained with the measuring device according to FIG. 5.

In the following Figures, the same elements are provided with the same reference numbers and will not be introduced again.

FIG. 1 shows a schematic view from the side of the essential parts of a filter tipping machine. The filter tipping machine, e.g. of the type MAX by the applicant, comprises a transfer drum 2 for transferring cigarettes of double the usable length which are produced by a cigarette-making machine. Following this, the cigarettes with double the usable length are supplied to a tobacco rod cutting drum 3, which cuts the tobacco rods into two individual tobacco rods and/or cigarettes of a single usable length. Following the cutting of the tobacco rod, the individual rod sections are supplied to a spreading drum 4 which spreads out the tobacco rod sections in such a way that the filter elements can be placed in-between. The tobacco rod sections and/or cigarettes, spaced apart in this way, are then supplied to a feeding drum 5.

The feeding drum 5 is furthermore supplied with filter elements which are inserted in a position between the tobacco rods on the feeding drum 5, meaning into the respective receiving troughs on the feeding drum 5. For this exemplary embodiment, a filter element has already been deposited by the drum 13 in the center of the receiving trough in the feeding drum 5 at the moment when the filter elements are deposited by the drum 12. Once the filter elements have been deposited by the drum 12 on the drum 5, that is against the outer ends of the filter element already deposited in a receiving trough, the tobacco rod sections are then deposited by the drum 4 on the outside of the receiving troughs.

Prior to depositing the filter elements from the drum 12 into the drum 5, a cutting and removal drum 6 first removes filter elements from a filter-element supply, an operation that is not shown in FIG. 1. With respect to the removal of filter elements from a filter-element supply, we refer to reference DE 25 05 998 C2, which corresponds to U.S. Pat. No. 4,020,973. For example, these can be multiple-component filter elements with 12 times the usable length, having the components 61, 62 and 63 as shown in FIG. 2. On the cutting drum 6, these are initially cut twice with circular knives 10 into multiple-component filter segments having 4 times the usable length. The multiple-component filter segments are staggered in the staggering drum 7 and are then initially aligned cross-axially in the sliding and cutting drum 8 before being cut again with a circular knife 10 into multi-segmented filter sections of twice the usable length. These filter elements are subsequently aligned again on the sliding and cutting drum 8, so that they can be cut once more with a circular knife 10 into single-length multi-segmented filters. These are transferred to a sliding drum 11 and are then transferred by means of an acceleration drum 12 to the feeding drum 5. Thus, following the transfer of the tobacco rod sections, the single-length multi-segmented filter elements adjoin the tobacco rod sections on the inside.

A different filter element with 12 times the usable length is removed by means of the cutting drum and/or the cutting/removal drum 15 in the known manner from a filter supply (see reference DE 25 05 998 C2, corresponding to U.S. Pat. No. 4,020,973, mentioned in the above). These filter segments are cut twice on the cutting drum 15 with circular knives 10, so that they can be transferred to a staggering drum 16. Following the staggering, the filter segments are then transferred to a sliding and cutting drum 17 where they are oriented so as to be aligned cross-axially and are cut twice into single-length filter elements. The single-length filter elements are then staggered in a staggering drum 18 and transferred to a sliding drum 19 where they are pushed together while aligned in longitudinal axial direction. A different acceleration drum 13 serves to insert these filter elements into the center of the respective receiving troughs in the feeding drum 5. For this exemplary embodiment, the last-mentioned single-length filter elements are inserted into the center of the receiving troughs in feeding drum 5. The additional single-length filter elements are then fitted against these on the outside and the respective tobacco rod sections are then placed against these on the extreme outer ends.

The tobacco rod/filter elements/tobacco rod groups and/or the cigarette—filter—cigarette—groups are then supplied to a transfer drum 21. First measurements are taken at this location with the aid of the first measuring location 41 which uses the incident light technique and/or the reflection technique to determine whether the filter components are complete, whether the filter component position is correct, whether the length of the individual components is correct and, if necessary, whether density deviations of individual filter components can be detected. A more detailed description is provided following the description of the filter tipping machine 1.

The correspondingly combined tobacco rod—filter elements—tobacco rod—groups are then transferred to a feeding drum 22, so that they can be pushed together in an orientation drum 23. A tipping paper web 52 that is pulled from a bobbin 50 and/or 51 is supplied with adhesive and is then cut in a cutting device 53 on a cutting drum 54 by the knives of a cutter drum 53 into separate tipping paper sections. The separate tipping paper sections are attached to the cigarette—filter—cigarette groups on the orientation drum 23 and are rolled on a rolling drum 24 in a known manner around the cigarette—filter—cigarette groups with the aid of a rolling hand 27 and a corresponding following acceleration element 26.

The finished double-length filter cigarettes are supplied via a transfer drum 28 and/or a drying drum 28 to a cutting drum 29 where they are fashioned into individual filter cigarettes by cutting through the center of the filter plugs. The individual filter cigarettes are then transferred to a transfer drum 31. On this transfer drum 31 and/or in this transfer drum 31 an additional measuring device 42 is provided, which determines by means of an incident light technique whether the tipping paper edge is in the correct position and whether the tipping paper was imprinted correctly. With respect to the measurements to be carried out we also want to refer to the following.

A turning drum 32 subsequently turns a filter-cigarette row and simultaneously transfers this row to the filter-cigarette row which moves through but has not been turned. Via a test drum 33, e.g. as described in reference DE 35 17 155 C2 which corresponds to U.S. Pat. No. 4,662,214, the filter cigarettes are moved to a discharge drum 34. A third measuring device 43 is located on this discharge drum 34 and/or at least partially inside this discharge drum 34 which determines by means of a light-transmission method whether gaps exist between the filter components or whether filter components are missing. Density deviations of individual filter components can furthermore also be measured at this location. We will also discuss this measuring device in further detail in the following.

The filter cigarettes subsequently travel to a transfer drum 36 and a blowout drum 37 where random cigarette samples can be removed with the aid of a removal drum 38. The non-removed filter cigarettes travel to a delivery drum 39, which deposits the filter cigarettes in the known manner on a delivery belt to generate a mass flow of filter cigarettes. Reference EP 0 692 201 B1, for example, discloses the generating of such a mass flow as well as a corresponding apparatus.

FIG. 2 schematically shows a cross-sectional representation of a portion of a tobacco rod—filter elements—tobacco rod—group. The tobacco rod 60 on the left is adjoined by a first filter element 61, a second filter element 62, a third filter elements 63, a fourth filter element 64 which is to be cut in the center, as indicated by the dashed lines. This is followed by a third filter element 63, a second filter element 62, a first filter element 61 and again a tobacco rod 60. A tipping paper roll 65 is also shown schematically.

The schematic view from the side in FIG. 3 shows a measuring device for measuring by means of an incident light technique. This is a first measuring device according to the invention and/or a third measuring device according to the invention. For the exemplary embodiment shown in FIG. 3, a cigarette—filter—cigarette—group is measured with an incident light technique. Shown is an exemplary embodiment having an angled radiation path, wherein a mirror 74 functions to deflect the radiation path at an angle. Light is radiated uniformly onto the cigarette—filter—cigarette—group by a light source that is not shown in FIG. 3. However, as shown in FIG. 3, it is only necessary to radiate light onto a section of the group, wherein the section comprising the filter components in particular is considered. In this exemplary embodiment, no tipping paper has yet been wound around the cigarette—filter—cigarette group. The light reflected by the components of the cigarette—filter—cigarette—group is concentrated via a lens 75 and supplied to a mirror 74 and is then focused by a collector lens 73 onto a line-sensitive detector, e.g. a CCD line 72. The camera 71, shown in FIG. 3, is installed inside a housing 70, together with the mirror 74 and the lens 75 and comprises a collector lens 73 and the CCD line 72. The typical radiation paths 76 are also shown herein.

A measuring result which must be viewed as exemplary is shown in FIG. 4b). This measuring result is generated, for example, with a cigarette—filter—cigarette—group as shown in FIG. 4a). The ordinate Y1 represents the pixel intensity of the CCD line 72 and/or the line camera 71 and the abscissa X1 represents the number of pixel elements. It is shown clearly that a relatively high amount of light is reflected by the cigarette 60 and the center filter element 64, whereas the dark filter elements 62 reflect a relatively small amount of light. The intermediate spaces between the filter elements 61, 62, 63 and 64 and/or between the respective filter element 61 and the cigarette rods 60 are characterized by intensity minimums which are relatively sharp. If a filter component is missing, practically no light reflection can be expected. As a result of signal variations at the transition locations for the filter elements, the precise location of the respective transitions can be determined, thus making it also possible to also determine the length of the individual components. Density deviations can also be detected if the required level of reflection for the respective filter elements can be preset, meaning for a corresponding density. The reflection degree will change in case of deviations.

A corresponding measuring device according to FIG. 3 is also used at a third measuring location, that is directly behind the location for the tipping paper wrapping or following the cutting of the cigarette—filter—cigarette groups. A measuring device 42 of this type makes it possible to measure the position of the tipping paper edge, wherein a slanted light incidence with uniform radiation must be selected such that a shadow is thrown at the edge, so that a corresponding contrast can be detected with the line-scanning camera 71. The location of the imprint on the tipping paper can also be detected easily. The location of the tipping paper imprint represents a contrast with the surface which can be converted easily with the line-scanning technique to a corresponding position signal.

The measuring devices using the incident light technique can also function with a straight radiation path. A straight radiation path of this type can be advantageous for certain spatial conditions. In that case, it is possible to have a uniform radiation coming from one or several sides.

FIG. 5 shows a schematic cross-sectional representation of a different measuring device, wherein this relates to the second measuring device 43. The measuring device 43 according to FIG. 5 operates by means of a light-transmission method. The filter cigarette is inserted into a receiving trough 84 of a drum body 82. Arranged in the drum body 82 are photodiodes 80 onto which light can impinge through openings 83 in the drum body 82. As shown in FIG. 5, the filter components 61 to 64 are positioned within the measuring range. The radiation for this exemplary embodiment is provided by a source 85 which comprises a plurality of light-emitting diodes 81.

As a result of the measuring technique according to the invention and/or this measuring principle, it is possible to detect serious deviations in the density of the filter components as well as gaps between filter components and missing filter components. Based on the fact that a high-grade local resolution of the internal contours of a filter is not possible with a light-transmission method, it is not necessary at this point to use a camera with high-resolution line-scanning which would result in additional costs.

FIG. 6 shows a typical measuring signal for a measuring device according to FIG. 5, wherein the intensity is plotted on the ordinate Y2 and the number of photodiodes are shown on the abscissa X2. Owing to the fact that the required local resolution does not have to be very high, a measurement is realized with an array and/or a group of light-emitting diodes and photodiodes. The light wavelength in that case can be in the visible or infrared range. Measured in each case is the radiated light that passes through the different filter regions. For an embodiment according to FIG. 5, the measuring range is between the drum inside and the area above the cigarette. For this, the radiation source is preferably arranged outside of the drum and the receiving element inside of the drum, thus making it possible to reduce the extraneous light effect to a minimum.

According to one method for the quality assurance of filter cigarettes with multi-segmented filters, the values for the radiation reflected by the filter components of the multi-segmented filters are compared in a first measuring device to first set values by means of a reflection technique, wherein the filter cigarette or the components of the filter cigarette are discarded and/or removed from further processing if the values deviate in excess of a first tolerance range. The measuring accuracy is increased if the values for the radiation that has passed through the filter components of the multi-segmented filters and the tipping paper wrapped around these components are compared in a second measuring device by means of the light-transmission method to second set values, wherein the filter cigarette is discarded if the deviation values exceed a second preset tolerance range. Combining these two methods results in an extremely precise analysis for determining whether the desired filter components exist and whether they are located at the correct locations. As a result, the errors for these measurements are minimized. If additionally the radiation reflected by a tipping paper wrapped around the multi-segmented filters is compared in a third measuring device by means of a reflection technique to third set values, wherein the filter cigarette is discarded if the values deviate in excess of a third preset tolerance range, the existence of incorrectly arranged tipping paper sections and/or incorrectly arranged imprints on the tipping paper sections can also be measured.

Reference Number List

1 filter tipping machine
2 transfer drum
3 tobacco rod cutting drum
4 spreading drum
5 feeding drum
6 cutting drum
7 staggering drum
8 sliding and cutting drum
10 circular knife
11 sliding drum
12 acceleration drum
13 acceleration drum
15 cutting drum
16 staggering drum
17 sliding and cutting drum
18 staggering drum
19 sliding drum
21 transfer drum
22 feeding drum
23 orientation drum
24 rolling drum
26 acceleration element
27 rolling hand
28 transfer drum
29 cutting drum
31 transfer drum
32 turning drum
33 test drum
34 discarding drum
36 transfer drum
37 blowout drum
38 removal drum
39 delivery drum
41.1 measuring location
42.2 measuring location
43.3 measuring location
50 bobbin
51 bobbin
52 tipping paper
53 tipping paper cutter
54 tipping paper drum
60 tobacco rod
61 1^{st} filter element
62. 2^{nd} filter element
63 3^{rd} filter element
64 4^{th} filter element
65 tipping paper roll
70 housing
71 camera
72 CCD line
73 collecting lens
74 mirror
75 lens
76 radiation path
80 photodiode
81 light-emitting diode
82 drum body
83 opening
84 receiving trough
85 radiation source
X1 number of pixel elements
Y1 pixel intensity
X1 number of photodiodes
Y2 intensity

1. A measuring device for measuring the properties of multi-segmented filters (61-64) in the tobacco-processing industry by means of a light-transmission method, wherein a radiation source (85) and a radiation receiver (82, 80) are provided and the radiation source (85) permits an essentially uniform radiation in longitudinal axial direction of a multi-segmented filter (61-64), characterized in that the radiation receiver (82, 80) is arranged within a conveying element (21, 31, 34) which is designed for conveying at least multi-segmented filters (61 to 64).

2. The measuring device according to claim 1, characterized in that the radiation source (85) comprises a plurality of individual radiation sources (81), arranged in longitudinal axial direction of a receiving trough provided in the conveying element (21, 31, 34).

3. The measuring device according to claim 2, characterized in that the radiation sources (81) are light-emitting diodes.

4. The measuring device according to claim 1, characterized in that the radiation receiver (72, 80) comprises at least one receiving element (72), in particular extending in longitudinal axial direction of a receiving trough arranged in the conveying element (21, 31, 34), or a plurality of receiving elements (80) that are arranged in longitudinal axial direction of a receiving trough arranged in the conveying element (21, 31, 34).

5. The measuring device according to claim 4, characterized in that photodiodes are used for the receiving elements (80).

6. A system for measuring the properties of rod-shaped articles in the tobacco-processing industry or components of rod-shaped articles that are subsequently combined to form rod-shaped articles, in particular multi-segmented filters (61 to 64) and/or filter cigarettes provided with multi-segmented filters (61 to 64) by using a first measuring device (41) for measuring the articles or components of the articles with a reflection technique, characterized in that a second measuring device (43) is provided for measuring the articles or components of the articles by means of a light-transmission method.

7. The measuring system according to claim 6, characterized in that the second measuring device (43) is a measuring device for measuring the properties of multi-segmented filters (61-64) in the tobacco-processing industry by means of a light-transmission method, wherein a radiation source (85) and a radiation receiver (82, 80) are provided and the radiation source (85) permits an essentially uniform radiation in longitudinal axial direction of a multi-segmented filter (61-64), characterized in that the radiation receiver (82, 80) is arranged within a conveying element (21, 31, 34) which is designed for conveying at least multi-segmented filters (61 to 64).

8. The measuring system according to claim 6, characterized in that a third measuring device (42) is provided, by means of which the articles or components of the articles are measured with a reflection technique.

9. The measuring system according to claim 6, characterized in that the measuring devices (41 to 43) are arranged in and/or on a filter tipping machine (1).

10. The measuring system according to claim 9, characterized in that the first measuring device (41) is arranged in a region of the production process for rod-shaped articles that is located downstream of a station (5) for combining the components (60 to 64) or the articles.

11. The measuring system according to claim 10, characterized in that the first measuring device (41) is arranged on and/or in a transfer drum (21) that is located downstream of the first drum (5) which combines the components.

12. The measuring system according to claim 9, characterized in that the second and/or third measuring device (42, 43) is arranged in a region where rod-shaped articles are produced and which is located downstream of a station (23, 24) where an article (60 to 64) is wrapped at least partially with a tipping paper (52).

13. The measuring system according to claim 10, characterized in that the station consists at least in part of drums.

14. The measuring system according to claim 6, characterized in that the first and/or the third measuring device (41, 43) comprises a radiation source (85) by means of which rod-shaped articles or components (60 to 64) of rod-shaped articles essentially can be radiated within a measuring range and that the first and/or third measuring device (41, 43) comprises a radiation receiver (72) for receiving the radiation reflected by the articles (60 to 64) or the components (60 to 64, 52).

15. The measuring system according to claim 14, characterized in that the radiation receiver (72, 80) comprises several receiving elements (80) that are arranged in a row.

16. The measuring system according to claim 14, characterized in that the radiation receiver (72, 80) is a position-sensitive receiver that extends in at least one direction and, in particular, comprises a charge-coupled device (CCD).

17. A filter tipping machine (1) with a system for measuring the properties of rod-shaped articles in the tobacco-processing industry or components of rod-shaped articles that are subsequently combined to form rod-shaped articles, in particular multi-segmented filters (61 to 64) and/or filter cigarettes provided with multi-segmented filters (61 to 64) by using a first measuring device (41) for measuring the articles or components of the articles with a reflection technique, characterized in that a second measuring device (43) is provided for measuring the articles or components of the articles by means of a light-transmission method, wherein at least one of the measuring devices is for measuring the properties of multi-segmented filters (61-64) in the tobacco-processing industry by means of a light-transmission method, wherein a radiation source (85) and a radiation receiver (82, 80) are provided and the radiation source (85) permits an essentially uniform radiation in longitudinal axial direction of a multi-segmented filter (61-64), characterized in that the radiation receiver (82, 80) is arranged within a conveying element (21, 31, 34) which is designed for conveying at least multi-segmented filters (61 to 64).

18. A quality assurance method for filter cigarettes with multi-segmented filters (61 to 64), wherein the values for the radiation reflected by the filter components (61 to 64) of the multi-segmented filter are compared to first set values with the aid of a reflection technique and in a first measuring device (41) and wherein the filter cigarette or the components (60 to 64) of the filter cigarette are discarded if the deviations exceed the values of a first preset tolerance range.

19. The method according to claim 18, characterized in that the radiation which has passed through the filter components of the multi-segmented filter and a tipping paper (52) that is wrapped around these components is compared in a second measuring device (43) to second set values by means of a light-transmission method, wherein the filter cigarette is discarded if the values deviate by exceeding a second preset tolerance range.

20. The method according to claim 18, characterized in that the radiation reflected by the tipping paper (52), wrapped around the multi-segmented filter (61-64), is compared to third set values in a third measuring device (42) by means of a reflection technique, wherein the filter cigarette is discarded if the values deviate by exceeding a preset third tolerance range.
